(19) United States
(12) Patent Application Publication
(10) Pub. No.: US 2020/0031164 A1
(43) Pub. Date: Jan. 30, 2020

(54) VEHICULAR BEARING DEVICE

(71) Applicant: JTEKT CORPORATION, Osaka (JP)

(72) Inventor: Hiroshi ANNO, Sakai-shi (JP)

(73) Assignee: JTEKT CORPORATION, Osaka (JP)

(21) Appl. No.: 16/516,572

(22) Filed: Jul. 19, 2019

(30) Foreign Application Priority Data
Jul. 25, 2018 (JP) 2018-138977

(51) Int. Cl. B60B 27/00; B60B 27/02; F16C 19/18

(52) U.S. Cl. CPC B60B 27/0073; B60B 27/02; F16C 19/184; F16C 2326/02; B60B 27/0094; B60B 27/0005; B60B 2900/211

(57) ABSTRACT

An inner shaft provided in a vehicular bearing device includes a shaft-shaped body portion and a flange portion. The flange portion includes: a flange base portion that is continuous with the body portion and that has a circular cross section; a plurality of first thick portions each provided with a bolt hole, the first thick portions being provided radially outward of the flange base portion at equal intervals in a circumferential direction; and a thin portion that is provided between the first thick portions and that is thinner than the first thick portions. The flange base portion includes: a second thick portion that is positioned radially inward of the first thick portion and that is thicker than the first thick portion; and a small-diameter portion that is positioned radially inward of the thick portion and that has a smaller diameter than that of the second thick portion.

### INCORPORATION BY REFERENCE

The disclosure of Japanese Patent Application No. 2018-138977 filed Jul. 25, 2018 including the specification, drawings and abstract, is incorporated herein by reference in its entirety.

### BACKGROUND OF THE INVENTION

### 1. Field of the Invention

The invention relates to a vehicular bearing device.

### 2. Description of the Related Art

A vehicular bearing device called a hub unit is used for attaching a wheel and a brake disk to a vehicle body of a vehicle (refer to, for example, Japanese Patent Application Publication No. 2005-96681 (JP 2005-96681 A)). The vehicular bearing device includes an inner shaft that has a flange portion for attaching a wheel etc. FIG. 6 is a perspective view of an inner shaft 90 according to the related art. FIG. 7 is a view of the inner shaft 90 as seen in an axial direction. The inner shaft 90 has a body portion 91 that has a shaft shape and a flange portion 92 that is provided on one side of the body portion 91 in the axial direction. A plurality of bolt holes 93 are formed in the flange portion 92. The bolt holes 93 are for attaching a wheel (not illustrated).

The flange portion 92 has a flange base portion 94 that has a cross section with a circular shape and that is continuous with the body portion 91. The flange portion 92 includes a plurality of thick portions 95 that are provided radially outward of the flange base portion 94 at equal intervals in a circumferential direction, and thin portions 96 each provided between the thick portions 95. The thin portion 96 is thinner than the thick portion 95. In each thick portion 95, the bolt hole 93 is formed. Since the flange portion 92 has the thin portions 96, the weight of the vehicular bearing device can be reduced. The reduction of the weight of the vehicular bearing device leads to the reduction of the weight of the vehicle. When the weight of the vehicle is reduced, the amount of fuel consumed can be reduced and carbon dioxide emissions can be reduced.

The vehicular bearing device receives various loads that are generated between a road surface side and a vehicle body side. When the flange portion 92 is simply made thin in order to reduce the weight of the vehicular bearing device, the strength and rigidity are reduced and the traveling performance is lowered.

### SUMMARY OF THE INVENTION

An object of the invention is to reduce the weight of a vehicular bearing device while suppressing the effects of the reduced strength and rigidity.

According to an aspect of the invention, the vehicular bearing device includes: an inner shaft member; an outer ring that has a tubular shape; and a plurality of rolling elements that are provided between the inner shaft member and the outer ring, in which the inner shaft member has an inner shaft that includes a body portion that has a shaft shape, and a flange portion that is provided on one side of the body portion in an axial direction and in which a plurality of bolt holes for attaching a wheel are formed, the flange portion has a flange base portion that is continuous with the body portion and that has a circular cross section, a plurality of first thick portions each provided with the bolt hole, the first thick portions being provided radially outward of the flange base portion at equal intervals in a circumferential direction, and a thin portion that is provided between the first thick portions and that is thinner than the first thick portions, and the flange base portion has a second thick portion that is positioned radially inward of the first thick portion and that is thicker than the first thick portion, and a small-diameter portion that is positioned radially inward of the thin portion and that has a smaller diameter than that of the second thick portion.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a sectional view of an example of a vehicular bearing device;

FIG. 2 is a perspective view of an inner shaft;

FIG. 3 is a view of the inner shaft as seen in an axial direction;

FIG. 4 is a perspective view of a second thick portion and its surroundings;

FIG. 5 is a sectional view as seen in a Y direction in FIG. 3;

FIG. 6 is a perspective view of an inner shaft according to the related art; and

FIG. 7 is a view of the inner shaft according to the related art as seen in the axial direction.

### DETAILED DESCRIPTION OF EMBODIMENTS

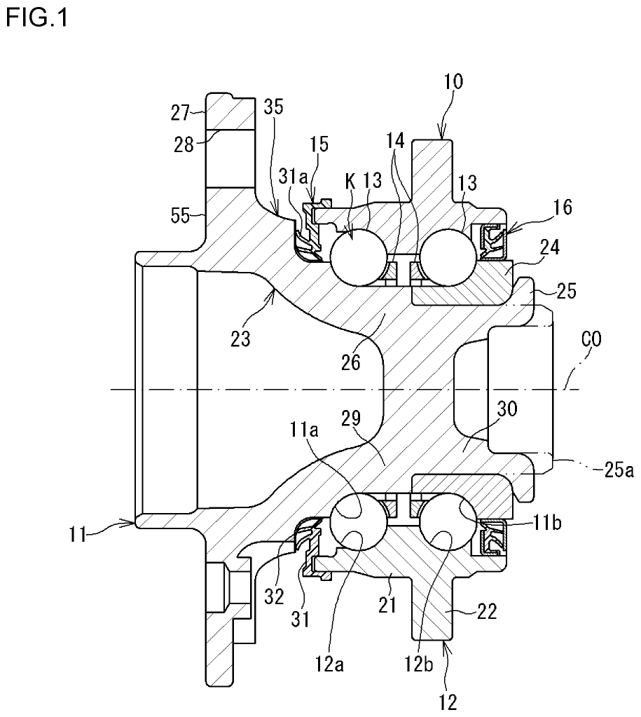

FIG. 1 is a sectional view of an example of a vehicular bearing device. A vehicular bearing device 10 illustrated in FIG. 1 (hereinafter referred to as a “bearing device 10”) is a so-called hub unit. The bearing device 10 is attached to a suspension system (knuckle) that is provided in a vehicle body of an automobile. The bearing device 10 supports a wheel so that the wheel is rotatable. Although not shown, a brake disc is attached to the bearing device 10 in addition to the wheel. The bearing device 10 includes an inner shaft member 11, an outer ring 12 that has a tubular shape, balls 13 that are rolling elements, a cage 14, a first sealing device 15 that is provided on one side in an axial direction, and a second sealing device 16 that is provided on the other side in the axial direction. In the bearing device 10, the axial direction is a direction along a center line C0 of the bearing device 10. A direction parallel to the center line C0 is also called the axial direction. The radial direction is a direction orthogonal to the center line C0. The circumferential direction is a rotational direction having the center line C0 as the center.

The outer ring 12 includes an outer ring body portion 21 that has cylindrical shape, and a flange portion 22 for fixing, which is provided so as to extend radially outward from the outer ring body portion 21. Outer ring raceway surfaces 12a, 12b are formed on an inner peripheral side of the outer ring body portion 21. The outer ring 12 is attached to the knuckle (not shown) that is a vehicle body side member. The bearing device 10 including the outer ring 12 is thus fixed to the vehicle body. When the bearing device 10 is fixed to the vehicle body, a flange portion 27 side is the outer side of the vehicle. The flange portion 27, described below, is for attaching the wheel and is provided in the inner shaft member 11. That is, the one side in the axial direction on which the flange portion 27 is provided is a vehicle outer side and the other side in the axial direction away from the vehicle outer side is a vehicle inner side.

The inner shaft member 11 has an inner shaft (hub shaft) 23 and an inner ring 24 that is attached to the other side of the inner shaft 23 in the axial direction. The inner shaft 23 has a body portion 26 that has a shaft shape and that is provided radially inward of the outer ring 12, and the flange portion 27 that is provided on the one side of the body portion 26 in the axial direction. A plurality of bolt holes 28 for attaching the wheel are provided in the flange portion 27. The inner shaft 23 also has a clinch portion 25 for suppressing the inner ring 24 from falling off toward the other side in the axial direction. The flange portion 27 is provided so as to extend radially outward from the one end of the body portion 26 in the axial direction. The wheel and a brake rotor (not shown) are attached to a surface (flange surface 55) on the one side of the flange portion 27 in the axial direction. The clinch portion 25 is formed by plastically deforming a portion 25a that had a cylindrical shape so that the diameter is increased. In FIG. 1, the portion 25a with a cylindrical shape before plastic deformation is illustrated by a long dashed double-short dashed line.

An outer peripheral surface of the body portion 26 has a stepped shape. That is, the body portion 26 has a first shaft portion 29 in which an inner raceway surface 11a is formed, and a second shaft portion 30 in which an outer peripheral surface has a smaller diameter than that of the first shaft portion 29. The portion 25a that had a cylindrical shape is plastically deformed so that the diameter is increased while the inner ring 24 is fitted onto the second shaft portion 30. Thus, the inner ring 24 is disposed between the first shaft portion 29 and the clinch portion 25.

The inner ring 24 is an annular member and is fitted onto and fixed to the second shaft portion 30. The first inner ring raceway surface 11a is formed on an outer peripheral surface of the first shaft portion 29. A second inner ring raceway surface 11b is formed on an outer peripheral surface of the inner ring 24. The balls 13 are disposed between the outer raceway surface 12a and the inner raceway surface 11a on the one side in the axial direction. The balls 13 are disposed between the outer raceway surface 12b and the inner raceway surface 11b on the other side in the axial direction.

The inner shaft 23, the inner ring 24, the outer ring 12, and the balls 13 that are constituent members of the bearing device 10 are made of steel (carbon steel, bearing steel). The cage 14 may be made of steel or resin.

An annular space K in which the balls 13 are provided is formed between the inner shaft member 11 (inner shaft 23) and the outer ring 12. The first sealing device 15 is provided on the one side of the annular space K in the axial direction and the second sealing device 16 is provided on the other side of the annular space K in the axial direction. The sealing devices 15, 16 suppress foreign matter from outside from entering the annular space K. The first sealing device 15 includes an annular sealing member 31 that is attached to the outer ring 12 and an annular slinger 32 that is attached along a flange base portion 35, described below, that is provided in the inner shaft 23. A part (lip portion 31a) of the sealing member 31 is in contact with the slinger 32. It is thus possible for the first sealing device 15 to suppress foreign matter from entering the annular space K through a gap between the flange portion 27 and the outer ring 12.

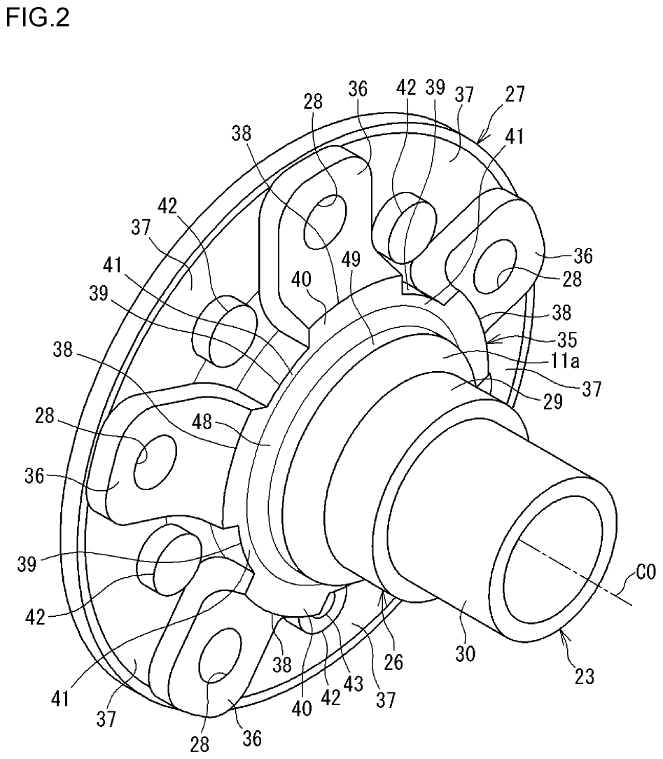

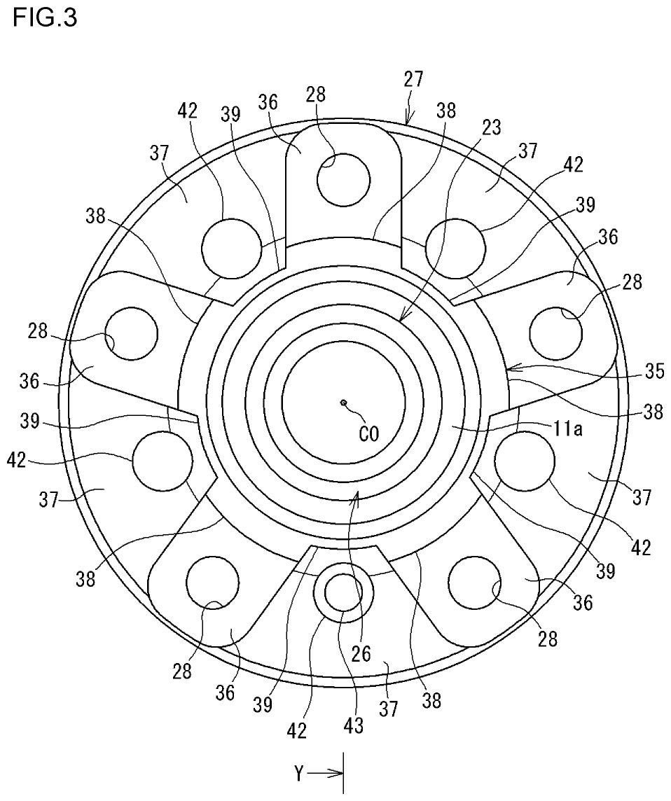

FIG. 2 is a perspective view of the inner shaft 23. FIG. 3 is a view of the inner shaft 23 as seen in the axial direction. A center line of the inner shaft 23 matches with the center line C0 of the bearing device 10. The flange portion 27 that has a disc shape includes the flange base portion 35 that is provided on an inner radial side and a plurality of first thick portions 36 and a plurality of thin portions 37 that are provided on an outer radial side. The flange base portion 35 has a circular shape (annular shape in the embodiment) in a cross section orthogonal to the center line C0 and is a part that is continuous with the body portion 26 that has a shaft shape. The flange base portion 35 has a circular shape in a cross section. However, the shape of the section is not constant along the circumferential direction. As described below, the flange base portion 35 has a plurality of second thick portions 38 and a plurality of small-diameter portions 39 that are arranged alternately, in which the second thick portions 38 and the small-diameter portions 39 have different sectional shapes. The first thick portions 36 are provided radially outward of the flange base portion 35 at equal intervals in the circumferential direction. In each first thick portion 36, the bolt hole 28 is formed. Each thin portion 37 is provided radially outward of the flange base portion 35, between the first thick portions 36, 36 that are adjacent in the circumferential direction. The thin portion 37 is thinner than the first thick portion 36. That is, the size of the thin portion 37 in the axial direction is smaller than that of the first thick portion 36. Since the bolt hole 28 is provided in the first thick portion 36, the number of first thick portions 36 is the same as the number of bolt holes 28 (in the embodiment, the number is “five”).

The flange portion 27 has a raised portion 42. In the embodiment, a plurality of the raised portions 42 are provided at equal intervals along the circumferential direction. A tap hole 43 is formed in the raised portion 42. The tap hole 43 is for temporarily fixing a brake rotor (not shown). The tap hole 43 only needs to be formed in one of the raised portions 42. Since the raised portions 42 are provided at equal intervals, the weight balance in the flange portion 27 is suppressed from deteriorating.

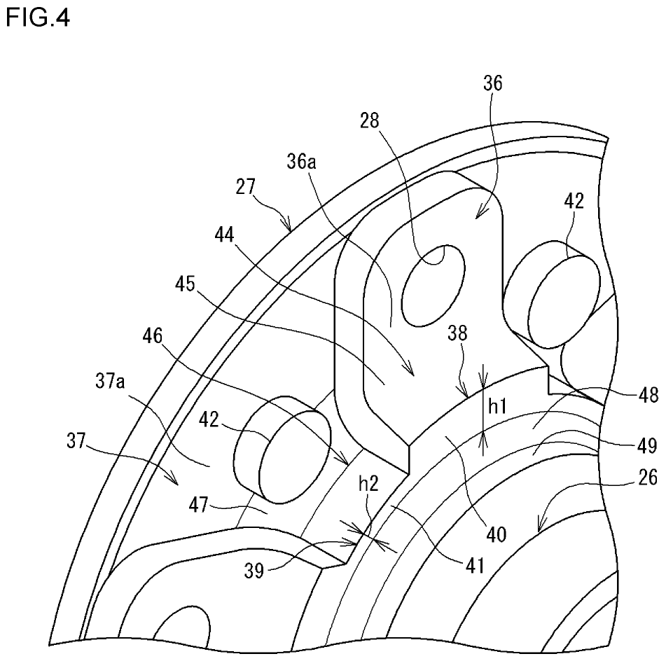

As described above, the flange base portion 35 is formed of the second thick portions 38 and the small-diameter portions 39. The second thick portions 38 and the small-diameter portions 39 are arranged alternately along the circumferential direction. Since the flange base portion 35 has an annular shape, each second thick portion 38 and small-diameter portion 39 has an arc shape. The second thick portion 38 is positioned radially inward of the first thick portion 36 and is thicker than the first thick portion 36. FIG. 4 is a perspective view of the second thick portion 38 and its surroundings. The second thick portion 38 that has an arc shape includes a first radially outward surface 44. The radially outward surface 44 has a first slope 45 that is tilted radially outward toward the one side in the axial direction. The slope 45 is continuous with a side face 36a of the first thick portion 36. In this way, the second thick portion 38 and the first thick portion 36 are provided so as to be continuous along the radial direction. Each second thick portion 38 also has a large arc face 40 that faces the axial direction.

The small-diameter portion 39 is positioned radially inward of the thin portion 37. In FIG. 4, the small-diameter portion 39 that has an arc shape includes a second radially outward surface 46. The radially outward surface 46 has a second slope 47 that is tilted radially outward toward the one side in the axial direction. The slope 47 is continuous with a side face 37a of the thin portion 37. In this way, the small-diameter portion 39 and the thin portion 37 are provided so as to be continuous along the radial direction. The second radially outward surface 46 provided in the small-diameter portion 39 is smaller in size in the radial direction than the first radially outward surface 44 provided in the second thick portion 38. That is, the small-diameter portion 39 has smaller diameter than that of the second thick portion 38. Each small-diameter portion 39 also has a small arc face 41 that faces the axial direction.

As described above, the first sealing device 15 (see FIG. 1) includes the annular sealing member 31 that is attached to the outer ring 12 and the annular slinger 32 that is attached along the flange base portion 35. In FIG. 4, the slinger 32 is attached so as to be in contact with the large arc face 40 of the second thick portion 38 and an end portion outer peripheral surface 49 that is provided in the body portion 26 and that faces radially outward. A concave surface 48 is provided between the large arc face 40 and the end portion outer peripheral surface 49. In the concave surface 48, the diameter changes along the axial direction. A clearance may be provided between the slinger 32 and the concave surface 48. In the concave surface 48, the sectional shape is constant (does not change) along the circumferential direction.

The large arc face 40 of the second thick portion 38 and the small arc face 41 of the small-diameter portion 39 are provided radially outward of the concave surface 48. The large arc face 40 and the small arc face 41 are provided on a common virtual plane that has an annular shape. The large arc face 40 and the small arc face 41 are formed so as to be continuous with the concave surface 48. Since the small-diameter portion 39 has a smaller diameter than that of the second thick portion 38, a radial dimension h2 of the small arc face 41 is smaller than a radial dimension h1 of the large arc face 40. The radial dimension h2 of the small arc face 41 is around one millimeter. The slinger 32 is in contact with the end portion outer peripheral surface 49 in the radial direction. The slinger 32 is attached so as to be in contact with the small arc face 41 in the axial direction, in addition to the large arc face 40.

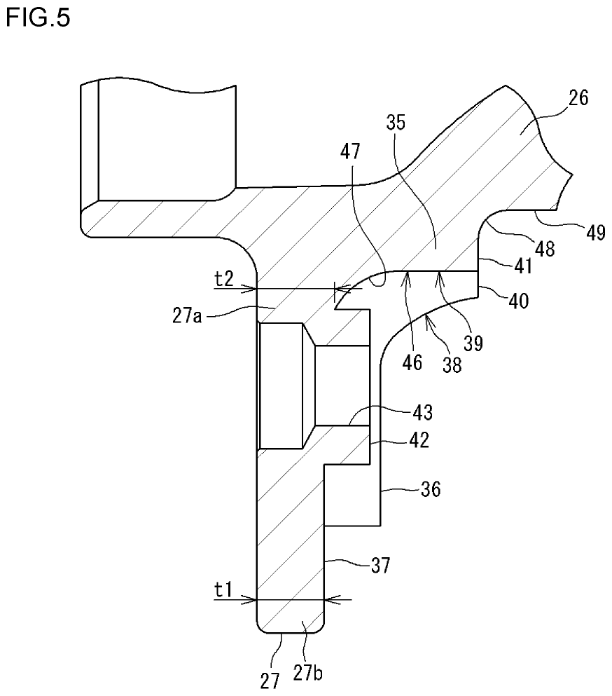

The small-diameter portion 39 that is smaller in the radial direction compared to the second thick portion 38 is provided. The thickness (axial dimension) of a radially inward area of the flange portion 27 is thus partially thin. FIG. 5 is a sectional view as seen in a Y direction in FIG. 3, and illustrates the small-diameter portion 39 and its surroundings. A thickness t2 (axial dimension t2) of a radially inward portion 27a of the flange portion 27 that is thin due to the small-diameter portion 39 is set to be equal to or more than a thickness t1 (axial dimension t1) of a radially outward portion 27b of the flange portion 27, that is, the thin portion 37. This suppresses the flange portion 27 from being excessively thin due to the small-diameter portion 39. With the small-diameter portion 39 being formed as described above, the raised portion 42 is provided so as to have a shape of an isolated island.

In the bearing device 10 of the embodiment (see FIGS. 2 and 3), the inner shaft 23 includes the body portion 26 that has a shaft shape and the flange portion 27 that is provided with the bolt holes 28. The flange portion 27 includes the annular flange base portion 35 that is continuous with the body portion 26, the first thick portion 36, and the thin portion 37. The first thick portions 36 are provided radially outward of the flange base portion 35 at equal intervals in the circumferential direction, and are parts in which the bolt holes 28 are formed. Thus, load from the wheel side directly acts on each first thick portion 36. The thin portion 37 is provided between the first thick portions 36 and is thinner (has a smaller axial dimension) than the first thick portions 36. The bolt hole 28 is not formed in the thin portion 37. Thus, load from the wheel side does not directly act on the thin portion 37. The flange base portion 35 has the second thick portion 38 and the small-diameter portion 39. The second thick portion 38 is positioned radially inward of the first thick portion 36 and is thicker than the first thick portion 36. The small-diameter portion 39 is positioned radially inward of the thin portion 37 and has a smaller diameter than that of the second thick portion 38.

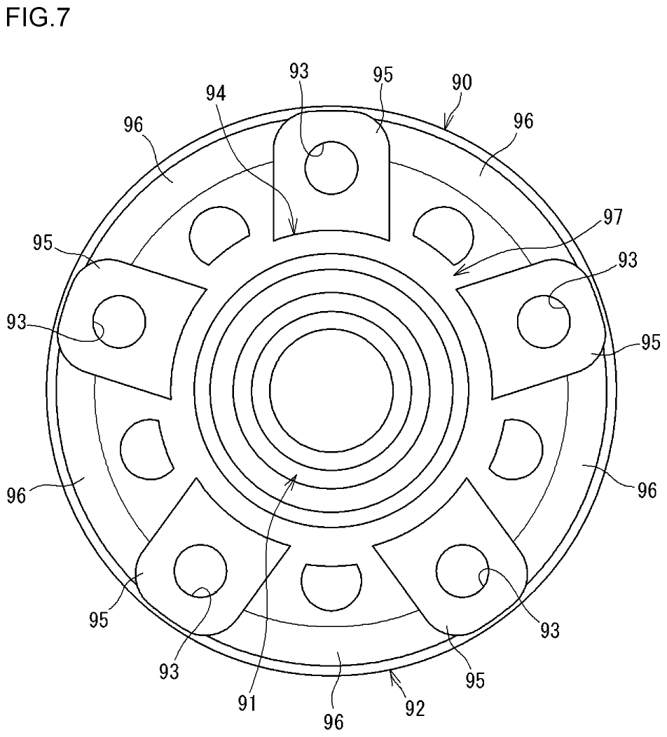

In the related art (see FIGS. 7 and 8), in a radially outward surface 97a of the flange base portion 97 that has a circular cross section, the diameter is the same throughout the entire circumference. In contrast, in the outer peripheral surface of the flange base portion 35 of the embodiment (see FIGS. 2 and 3), the diameter of the second thick portion 38 is large and the diameter of the small-diameter portion 39 is small.

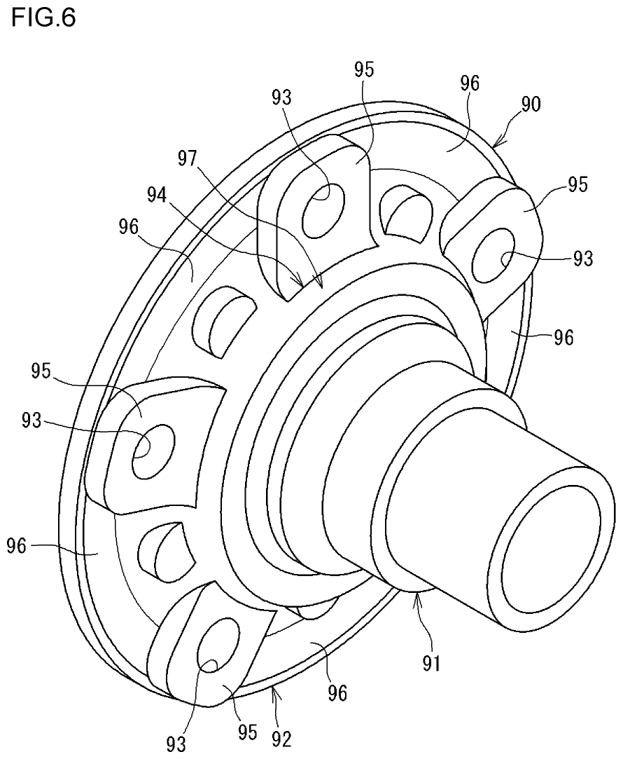

In the embodiment, the second thick portions 38 and the small-diameter portions 39 are arranged alternately along the circumferential direction in the flange base portion 35 that has a circular cross section. The small-diameter portion 39 has a smaller diameter that is smaller than that of the second thick portion 38. Compared to the structure (see FIGS. 6 and 7) of the related art, the weight of the flange portion 27 is further reduced due to the small-diameter portion 39. The small-diameter portion 39 is positioned radially inward of the thin portion 37 in which the bolt hole 28 is not formed. In contrast, the second thick portion 38 is provided radially inward of the first thick portion 36 in which the bolt hole 28 is formed. In the embodiment, high rigidity portions each having a shape of a peninsula extending from the center side of the flange portion 27 in the radial direction are formed due to the first thick portions 36 and the second thick portions 38. The strength and rigidity of the flange portion 27 is thus ensured. In the flange portion 27, parts other than the high rigidity portions (thin portions 37 and small-diameter portions 39) are relatively thin, which contributes to reducing the weight of the inner shaft 23.

The load occurs in the bearing device 10 between the road surface side and the vehicle body side. The load is transmitted mainly via the first thick portions 36 in which the bolt holes 28 for being coupled with the wheel etc. are formed, and the second thick portions 38 that is continuous radially inward with the first thick portion 36. In the embodiment, it is thus possible to reduce the weight of the vehicular bearing device while suppressing the effects of the decreased strength and rigidity of the inner shaft 23. The flange portion 27 is thinned due to the small-diameter portion 39. The small-diameter portion 39 is a part that has relatively little influence on the rigidity from the viewpoint of a transmission path of the load, and such parts are thinned in the embodiment.

In the embodiment, the first sealing device 15 (see FIG. 1) has the sealing member 31 and the slinger 32. The slinger 32 is in contact with and is supported by the large arc face 40 provided in the second thick portion 38. With this structure, the slinger 32 is attached along the large arc face 40. Due to the large arc face 40, positioning of the slinger 32 becomes easier to determine the position of the slinger 32 in the axial direction.

The small arc face 41 and the large arc face 40 provided in the small-diameter portion 39 are provided along a common virtual plane. With this structure, the slinger 32 is attached along not only the large arc face 40 of the second thick portion 38, but also along the small arc face 41 of the small-diameter portion 39. In order to suppress foreign matter such as water from entering through a gap between the slinger 32 and the flange portion 27, it is preferable that a filler (sealing agent) be provided between the slinger 32 and the flange portion 27. From the viewpoint of providing such a filler, it is preferable that the small-diameter portion 39 have the small arc face 41 that is able to be in surface-contact with the slinger 32. In order to provide the filler between the slinger 32 and the flange portion 27 (flange base portion 35) along the entire circumference, it is preferable that the radial dimension h2 (see FIG. 4) of the small arc face 41 be equal to or more than one millimeter. The radial dimension h2 is less than the radial dimension h1 of the large arc face 40.

In the embodiment, the radial dimension h2 of the small arc face 41 is around one millimeter and the small arc face 41 is narrow in the radial direction. The lip portion 31a of the sealing member 31 can be in contact with the large arc face 40, but cannot be in direct contact with the small arc face 41. In the embodiment, the slinger 32 is provided and the lip portion 31a is in contact with the slinger 32. As a modification, the slinger 32 may be omitted if the radial dimension h2 of the small arc face 41 is larger than that in the configuration described above and the lip portion 31a is able to be in contact with the small arc face 41. In this case, the lip portion 31a is in contact with the large arc face 40 and the small arc face 41 that is continuous with the large arc face 40 in the circumferential direction.

The embodiments disclosed above are to be considered as illustrative and not restrictive in all respects. The scope of right of the invention is not limited to the embodiments described above, and includes all modifications within the scope equivalent to the configuration described in the claims. For example, the rolling elements are described as the balls 13. However, the rolling elements may be rollers (tapered rollers).

With the invention, it is possible to reduce the weight of the vehicular bearing device while suppressing the effects of the decreased strength and rigidity.

What is claimed is:

1. A vehicular bearing device comprising:
an inner shaft member; an outer ring that has a tubular shape; and a plurality of rolling elements that are provided between the inner shaft member and the outer ring, wherein
the inner shaft member has an inner shaft that includes a body portion that has a shaft shape, and a flange portion that is provided on one side of the body portion in an axial direction and in which a plurality of bolt holes for attaching a wheel are formed,
the flange portion has a flange base portion that is continuous with the body portion and that has a circular cross section, a plurality of first thick portions each provided with the bolt hole, the first thick portions being provided radially outward of the flange base portion at equal intervals in a circumferential direction, and a thin portion that is provided between the first thick portions and that is thinner than the first thick portions, and
the flange base portion has a second thick portion that is positioned radially inward of the first thick portion and that is thicker than the first thick portion, and a small-diameter portion that is positioned radially inward of the thin portion and that has a smaller diameter than that of the second thick portion.

2. The vehicular bearing device according to claim 1, further comprising
a sealing device that is provided between the inner shaft member and the outer ring and that suppresses foreign matter from entering an annular space in which the rolling elements are provided, wherein
the sealing device has a sealing member that is attached to the outer ring, and a slinger that is attached along the flange base portion and with which a part of the sealing member is in contact, and
the second thick portion has a large arc face that is in contact with and that supports the slinger in the axial direction.

3. The vehicular bearing device according to claim 2, wherein the small-diameter portion has a small arc face that is provided on a virtual plane in common with the large arc face.
